(19) United States
(12) Patent Application Publication
(10) Pub. No.: US 2026/0238433 A1
(43) Pub. Date: Aug. 13, 2026

(54) TIME DOMAIN CHANNEL PROPERTIES (TDCP) REPORTING

(71) Applicant: QUALCOMM INCORPORATED, San Diego, CA (US)

(72) Inventors: Jing DAI, Beijing (CN); Lei XIAO, San Jose, CA (US); Jae Ho RYU, San Diego, CA (US); Faris RASSAM, Spring Valley, CA (US)

(21) Appl. No.: 19/153,373

(22) PCT Filed: Apr. 7, 2023
(86) PCT No.: PCT/CN2023/086837

§ 371 Date: Aug. 4, 2025

(51) Int. Cl. H04L 5/00; H04W 72/21; H04W 76/28

(52) U.S. Cl. CPC H04L 5/0051; H04W 72/21; H04W 76/28

(57) ABSTRACT

Various aspects of the present disclosure generally relate to wireless communication. In some aspects, a user equipment (UE) may receive a tracking reference signal (TRS) via a first set of channel state information reference signal (CSI-RS) resources. The UE may receive a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources. The UE may transmit a time domain channel properties (TDCP) report indicating a time correlation calculation based at least in part on the delay between the first set of CSI-RS resources for the TRS and the second set of CSI-RS resources. Numerous other aspects are described.

### FIELD OF THE DISCLOSURE

Aspects of the present disclosure generally relate to wireless communication and to techniques and apparatuses for a time domain channel properties (TDCP) reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive a tracking reference signal (TRS) via a first set of channel state information reference signal (CSI-RS) resources; receive a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and transmit a time domain channel properties (TDCP) report indicating a time correlation calculation based at least in part on the delay between the first set of CSI-RS resources for the TRS and the second set of CSI-RS resources.

In some implementations, an apparatus for wireless communication at a network node includes a memory and one or more processors, coupled to the memory, configured to: transmit a TRS via a first set of CSI-RS resources; transmit a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and receive a TDCP report indicating a time correlation calculation based at least in part on the delay between the first set of CSI-RS resources for the TRS and the second set of CSI-RS resources.

In some implementations, a method of wireless communication performed by a UE includes receiving a TRS via a first set of CSI-RS resources; receiving a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and transmitting a TDCP report indicating a time correlation calculation based at least in part on the delay between the first set of CSI-RS resources for the TRS and the second set of CSI-RS resources.

In some implementations, a method of wireless communication performed by a network node includes transmitting a TRS via a first set of CSI-RS resources; transmitting a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and receiving a TDCP report indicating a time correlation calculation based at least in part on the delay between the first set of CSI-RS resources for the TRS and the second set of CSI-RS resources.

In some implementations, a non-transitory computer-readable medium storing a set of instructions for wireless communication includes one or more instructions that, when executed by one or more processors of a UE, cause the UE to: receive a TRS via a first set of CSI-RS resources; receive a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and transmit a TDCP report indicating a time correlation calculation based at least in part on the delay between the first set of CSI-RS resources for the TRS and the second set of CSI-RS resources.

In some implementations, a non-transitory computer-readable medium storing a set of instructions for wireless communication includes one or more instructions that, when executed by one or more processors of a network node, cause the network node to: transmit a TRS via a first set of CSI-RS resources; transmit a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and receive a TDCP report indicating a time correlation calculation based at least in part on the delay between the first set of CSI-RS resources for the TRS and the second set of CSI-RS resources.

In some implementations, an apparatus for wireless communication includes means for receiving a TRS via a first set of CSI-RS resources; means for receiving a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and means for transmitting a TDCP report indicating a time correlation calculation based at least in part on the delay between the first set of CSI-RS resources for the TRS and the second set of CSI-RS resources.

In some implementations, an apparatus for wireless communication includes means for transmitting a TRS via a first set of CSI-RS resources; means for transmitting a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and means for receiving a TDCP report indicating a time correlation calculation based at least in part on the delay between the first set of CSI-RS resources for the TRS and the second set of CSI-RS resources.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of multiple tracking reference signals (TRSs) for a time domain channel properties (TDCP) report, in accordance with the present disclosure.

FIGS. 5-11 are diagrams illustrating examples associated with a TDCP reporting, in accordance with the present disclosure.

FIGS. 12-13 are diagrams illustrating example processes associated with a TDCP reporting, in accordance with the present disclosure.

FIGS. 14-15 are diagrams of example apparatuses for wireless communication, in accordance with the present disclosure.

### DETAILED DESCRIPTION

One periodic tracking reference signal (TRS) may be configured for a user equipment (UE) loop tracking. The one periodic TRS may not be associated with a time domain channel properties (TDCP) report. Incremental TRS(s) may be employed in addition to the one periodic TRS. The incremental TRS(s) may be dedicated for the TDCP report. For example, the one periodic TRS may be a first TRS and an incremental TRS may be a second TRS. The second TRS may be associated with a same quasi co-location as the first TRS. When the second TRS is not needed for the UE loop tracking (e.g., the second TRS is redundant for the UE loop tracking) and is only dedicated for the TDCP report, having four channel state information reference signal (CSI-RS) resources for the second TRS may be unnecessary or redundant, and may result in an unnecessarily high reference signal overhead.

In some aspects described herein, a UE may receive, from a network node, a TRS via a first set of CSI-RS resources. The UE may receive, from the network node, a CSI-RS via a second set of CSI-RS resources. The second set of CSI-RS resources may have fewer CSI-RS resources than the first set of CSI-RS resources for a delay between the first set of CSI-RS resources for the TRS and the second set of CSI-RS resources. The UE may transmit, to the network node, a TDCP report indicating a time correlation calculation based at least in part on the delay between the first set of CSI-RS resources for the TRS and the second set of CSI-RS resources. Since the second set of CSI-RS resources may only be used for the TDCP report and not for the TRS, the second set of CSI-RS resources may have fewer CSI-RS resources than the first set of CSI-RS resources, thereby reducing a reference signal overhead. The reference signal overhead may improve a performance of the UE and/or the network node.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

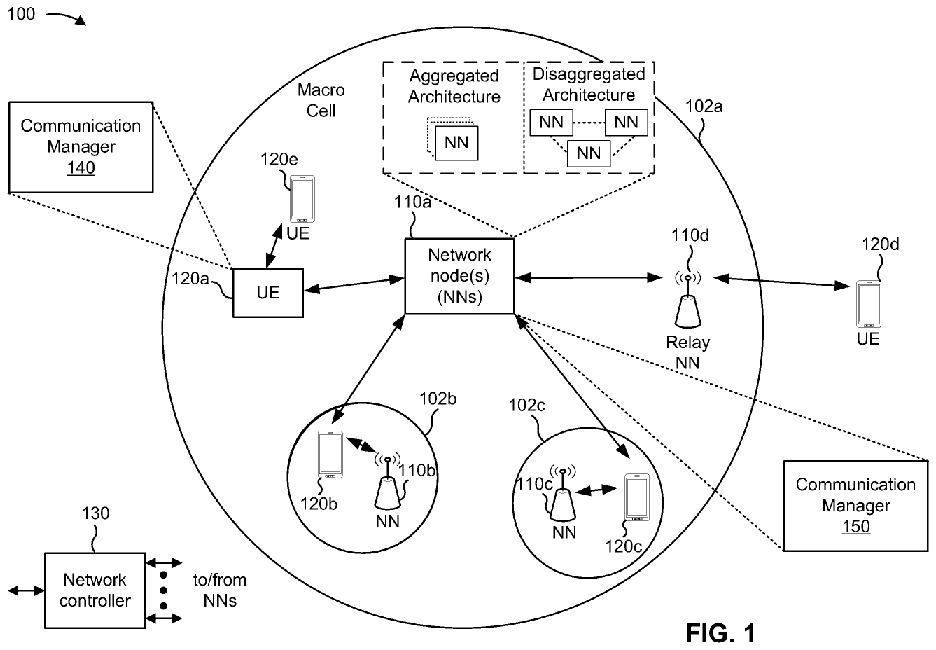

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive a TRS via a first set of CSI-RS resources; receive a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and transmit a TDCP report indicating a time correlation calculation based at least in part on the delay between the first set of CSI-RS resources for the TRS and the second set of CSI-RS resources. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a TRS via a first set of CSI-RS resources; transmit a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and receive a TDCP report indicating a time correlation calculation based at least in part on the delay between the first set of CSI-RS resources for the TRS and the second set of CSI-RS resources. Additionally, or alternatively, the communication manager 150 may perform one or more other operations described herein.

As indicated above, FIG. 1 is provided as an example. Other examples may differ from what is described with regard to FIG. 1.

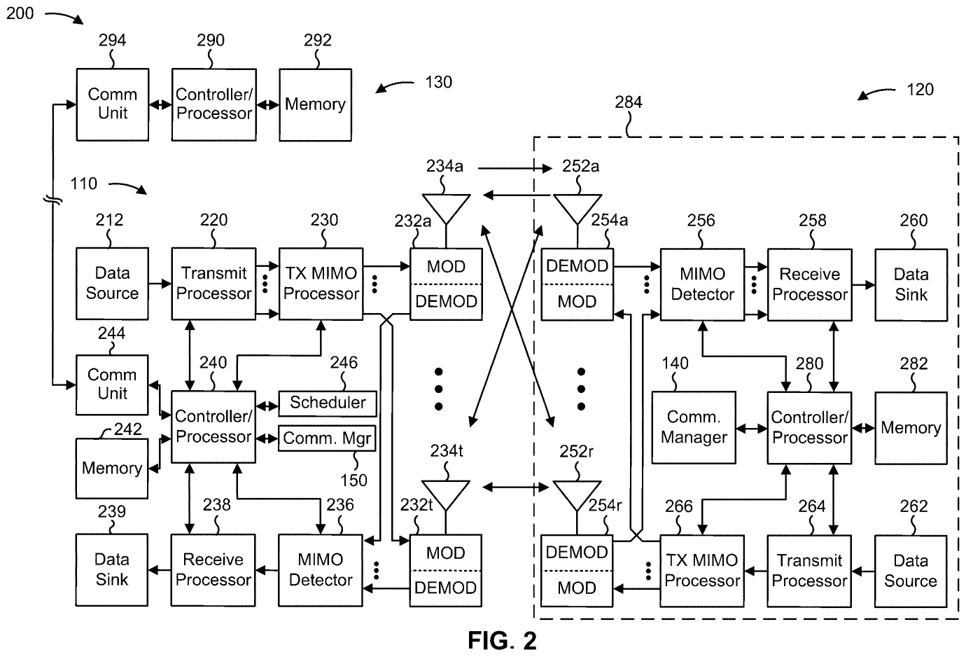

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

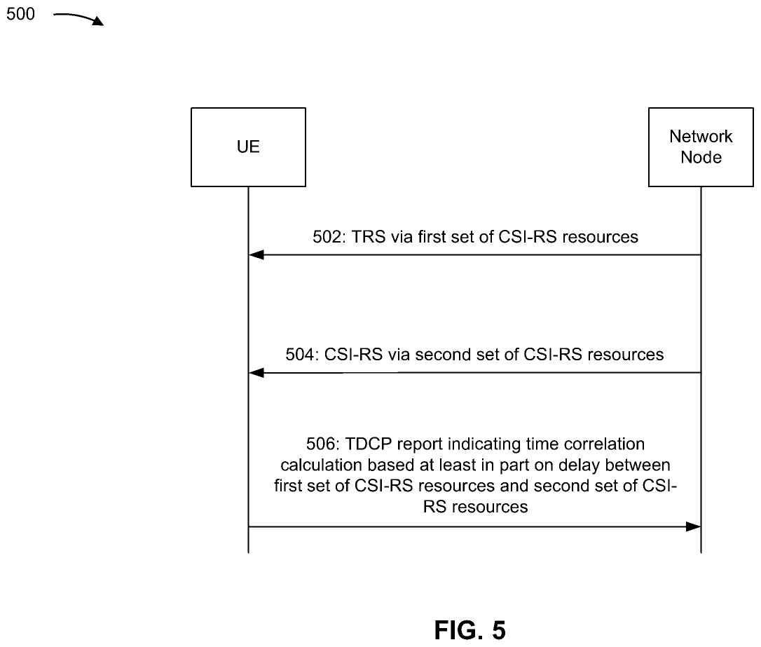

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-15).

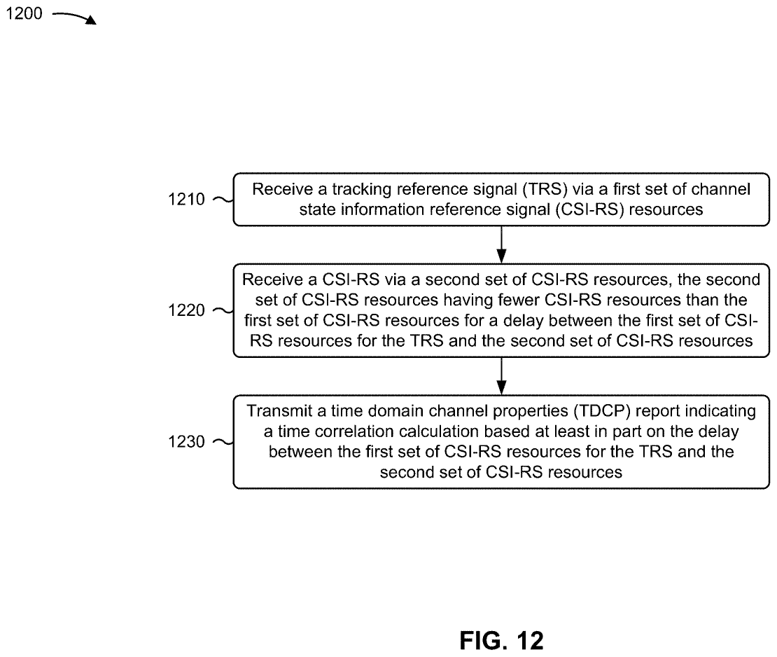

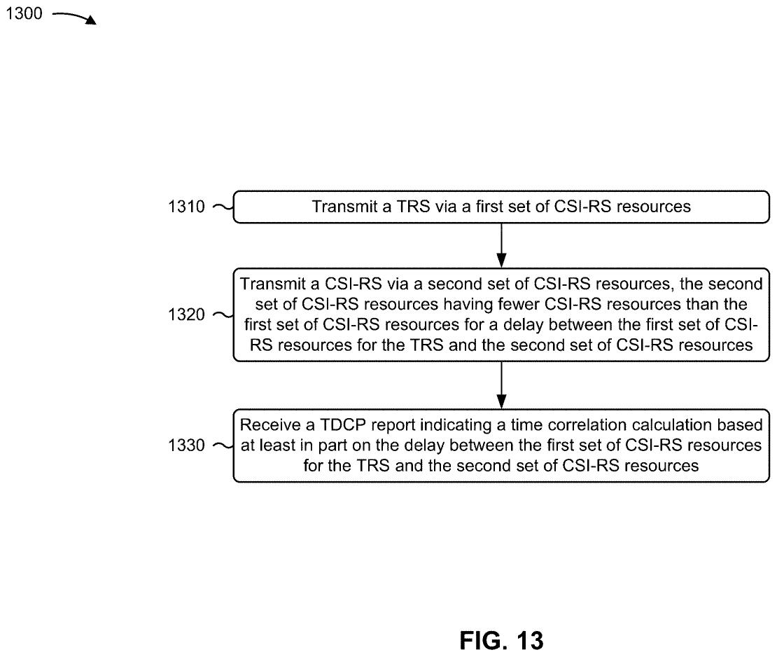

The controller/processor 240 of the network node 110, the controller/processor 280 of the UE 120, and/or any other component(s) of FIG. 2 may perform one or more techniques associated with a TDCP reporting, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving a TRS via a first set of CSI-RS resources; means for receiving a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and/or means for transmitting a TDCP report indicating a time correlation calculation based at least in part on the delay between the first set of CSI-RS resources for the TRS and the second set of CSI-RS resources. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a TRS via a first set of CSI-RS resources; means for transmitting a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and/or means for receiving a TDCP report indicating a time correlation calculation based at least in part on the delay between the first set of CSI-RS resources for the TRS and the second set of CSI-RS resources. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

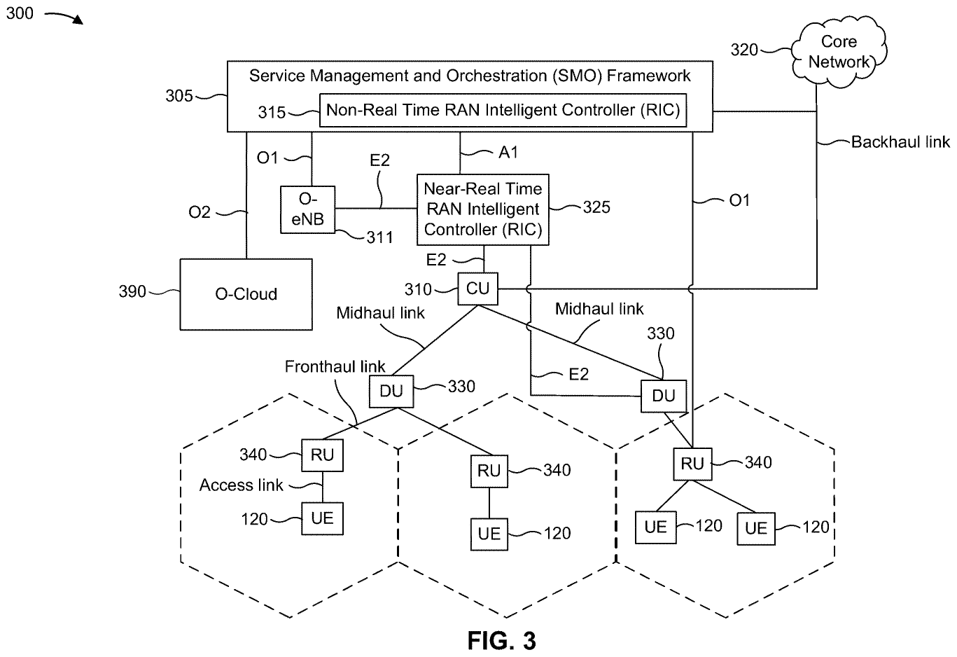

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A channel state information (CSI) reporting for high/medium UE velocities may be based at least in part on time domain correlation and/or Doppler domain information, which may assist a downlink precoding in FR1. The CSI reporting may involve a UE reporting of TDCP (a TDCP report). The TDCP may be measured via a CSI-RS for tracking.

A UE report of TDCP may be associated with various use cases, which may include a codebook switch (e.g., Type-I to Type-II), a channel sounding switch (e.g., CSI to sounding reference signal (SRS)), or a CSI/SRS periodicity, where a DMRS time density may be excluded. The UE report for TDCP may indicate a time correlation (or auto correlation). The time correlation may be associated with

$$A ( τ ) = \frac{\vert {\sum }_{k} {H}^{⋆} ( l - τ , k ) H ( l , k ) \vert}{\sqrt{{\sum }_{k} {\vert H ( l - τ , k ) \vert}^{2}} \sqrt{{\sum }_{k} {\vert H ( l , k ) \vert}^{2}}} ,$$

wherre l, k represent a time/frequency index, respectively, and τ represents a delay (lag). A slot-level (e.g., t=5 or 10 slots) delay (lag) may be relevant to the use cases. Time correlations associated with one or more delays (lags) may need to be reported.

For aiding a network node determination of codebook switching and an SRS periodicity with a TRS-based TDCP reporting, reporting a quantized wideband normalized amplitude/phase of a time domain correlation profile with Y≥1 may be supported. When Y=1 with delay≤D_{basic} symbols, only a wideband quantized normalized amplitude may be reported. When Y=1 with delay >D_{basic} symbols and Y ≥1, a wideband quantized normalized amplitude and phase for each delay may be reported. For Y>1, the phase may be configured to be absent for all of the Y delays. A value of Y may be configurable or may follow delays from a configured TRS resource. For the TRS-based TDCP reporting, regarding a value of parameter Y for Y>1, the value of Y may be network node configured via higher layer (e.g., RRC) signaling, the value of Y may follow the delays from the configured TRS resource, or the value of Y may be UE selected and reported, where the value of Y may be based at least in part on a UE capability.

A periodic TRS may support a 10, 20, 40, or 80 millisecond (ms) periodicity, which may be too long for delay (lag) values (e.g., 5 slots) of interest. Reducing a TRS periodicity may result in an increased overhead, so instead, multiple TRSs may be configured for the TDCP report. An offset between two TRSs may be a targeted delay (lag) for a time correlation calculation. A plurality of TRSs (e.g., all TRSs) for the TDCP report may be quasi co-located (otherwise cannot be used to derive the time correlation. To save overhead, a second TRS may have a longer periodicity than a first TRS (e.g., an integer multiple of a first TRS periodicity), since a TDCP may not need a frequent update. A TRS may be defined as a set of four single-port CSI-RS resources in two consecutive slots, or a set of two single-port CSI-RS resources in one single slot. The TRS may be configured using a TRS information (trs-Info) parameter. For example, a CSI-RS resource set may be configured via the TRS information parameter.

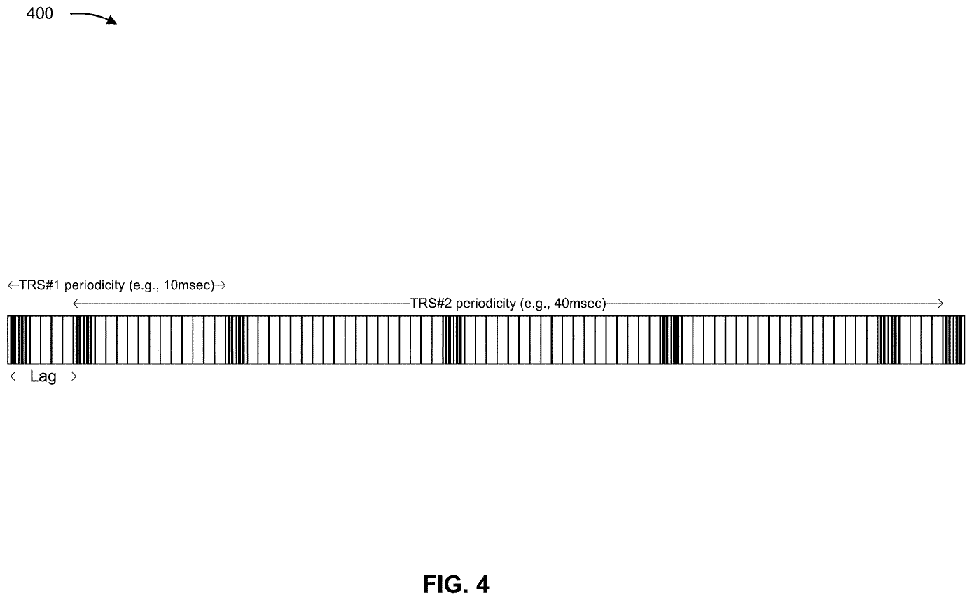

FIG. 4 is a diagram illustrating an example 400 of multiple TRSs for a TDCP report, in accordance with the present disclosure.

As shown in FIG. 4, multiple TRSs may be configured for a TDCP report. A first TRS (TRS #1) periodicity (e.g., 10 ms) and a second TRS (TRS #2) periodicity (e.g., 40 ms) may be configured. The second TRS periodicity may be longer than the first TRS periodicity. An offset between a first TRS and a second TRS may be a targeted delay (lag) for a time correlation calculation. The first TRS and the second TRS may be quasi co-located in order to derive the time correlation.

As indicated above, FIG. 4 is provided as an example. Other examples may differ from what is described with regard to FIG. 4.

One periodic TRS may be configured for a UE loop tracking. The one periodic TRS may not be associated with a TDCP report. Incremental TRS(s) may be employed in addition to the one periodic TRS. The incremental TRS(s) may be dedicated for the TDCP report. For example, the one periodic TRS may be a first TRS and an incremental TRS may be a second TRS. The second TRS may be associated with a same quasi co-location as the first TRS. When the second TRS is not needed for the UE loop tracking (e.g., the second TRS is redundant for the UE loop tracking) and is only dedicated for the TDCP report, having four CSI-RS resources for the second TRS may be redundant and may result in an unnecessarily high reference signal overhead.

In various aspects of techniques and apparatuses described herein, a UE may receive, from a network node, a TRS via a first set of CSI-RS resources. The UE may receive, from the network node, a CSI-RS via a second set of CSI-RS resources. The second set of CSI-RS resources may have fewer CSI-RS resources than the first set of CSI-RS resources for a delay between the first set of CSI-RS resources for the TRS and the second set of CSI-RS resources. The UE may transmit, to the network node, a TDCP report indicating a time correlation calculation based at least in part on the delay between the first set of CSI-RS resources for the TRS and the second set of CSI-RS resources. Since the second set of CSI-RS resources may only be used for the TDCP report and not for the TRS, the second set of CSI-RS resources may have fewer CSI-RS resources than the first set of CSI-RS resources, thereby reducing a reference signal overhead. The reference signal overhead may improve a performance of the UE and/or the network node.

FIG. 5 is a diagram illustrating an example 500 associated with a TDCP reporting, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

As shown by reference number 502, the UE may receive, from the network node, a TRS via a first set of CSI-RS resources. The TRS may be a periodic TRS, or alternatively, the TRS may be an aperiodic TRS. A subset of resources in the first set of CSI-RS resources for the TRS may be associated with a TDCP report, and the subset of resources in the first set of CSI-RS resources for the TRS may be based at least in part on the delay.

As shown by reference number 504, the UE may receive, from the network node, a CSI-RS via a second set of CSI-RS resources. The CSI-RS may be a periodic CSI-RS, or alternatively, the CSI-RS may be an aperiodic CSI-RS. The second set of CSI-RS resources may have fewer CSI-RS resources than the first set of CSI-RS resources for a delay between the first set of CSI-RS resources for the TRS and the second set of CSI-RS resources. The second set of CSI-RS resources may be associated with one delay. The second set of CSI-RS resources may be associated with more than one delay. Each delay may be associated with a group of CSI-RS resources within the second set of CSI-RS resources, and the group of CSI-RS resources may have one or two CSI-RS resources. In some cases, multiple delays may be configured for the TDCP report, and each delay of the multiple delays may be associated with a same subset of resources in the first set of CSI-RS resources for the TRS.

In some aspects, for a list (super set) of more than one set of CSI-RS resources configured for the TDCP report, the first set may be configured as the TRS. The first set may have a quantity of CSI-RS resources within the TRS (e.g., two or four CSI-RS resources). Other set(s) (e.g., the second set) may have a smaller quantity of CSI-RS resources per delay (lag) as compared to the first set.

In some aspects, in a first option, each of the other set(s) of CSI-RS resource(s) may be associated with one delay (lag). The first option may apply to a periodic TRS and CSI-RS case. A periodicity and offset (periodicityAndOffset) may be per resource configured. The first option may apply to an aperiodic TRS and CSI-RS case. An aperiodicity triggering offset (aperiodicityTriggeringOffset) may be per resource set configured. For the periodic TRS and CSI-RS case, for a resource set other than the first set (TRS), each CSI-RS resource periodicity may be the same, which may result in the measurement of delays (e.g., delay A and delay B) the same frequently (e.g., same frequent measure of two delays). Further, for the first option, the smaller quantity of CSI-RS resources in the other set(s) (e.g., one or two CSI-RS resources) may be smaller than the quantity of CSI-RS resources in the first set (e.g., two or four CSI-RS resources).

In some aspects, in a second option, a plurality of CSI-RS resources (e.g., all CSI-RS resources) other than the quantity of CSI-RSs in the first set (TRS) may be configured in a second set, and the plurality of CSI-RS resources may be associated with one or more delays (lags). The second option may only apply to the periodic TRS and CSI-RS case, where the periodicity and offset (periodicityAndOffset) are per resource configured, and an existing standard may already guarantee a same periodicity within a same resource set (e.g., the second set). Further, for the second option, each delay (lag) may be associated with a group of one (or two) CSI-RS resources within the second set.

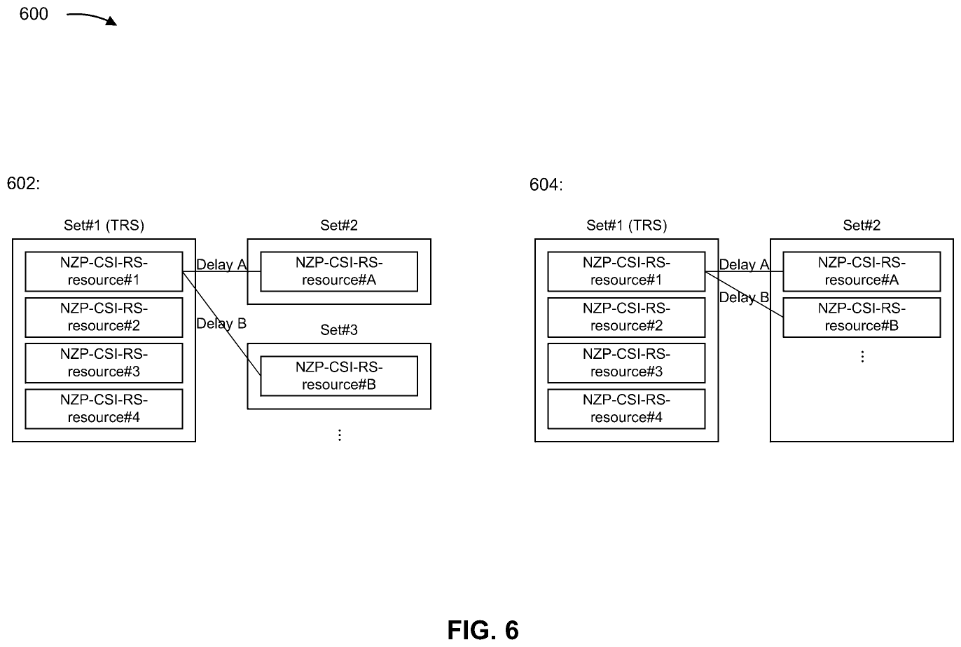

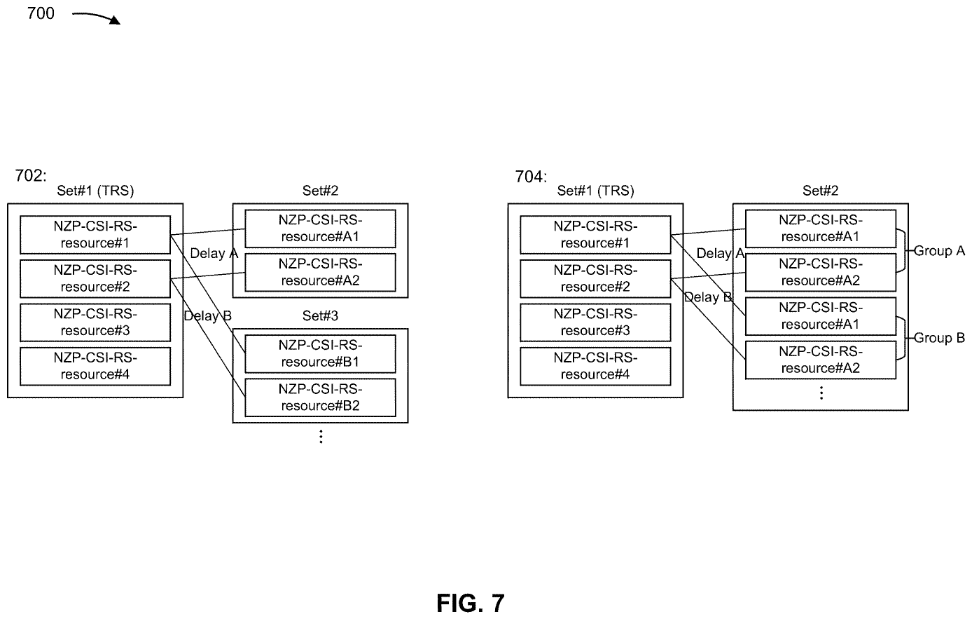

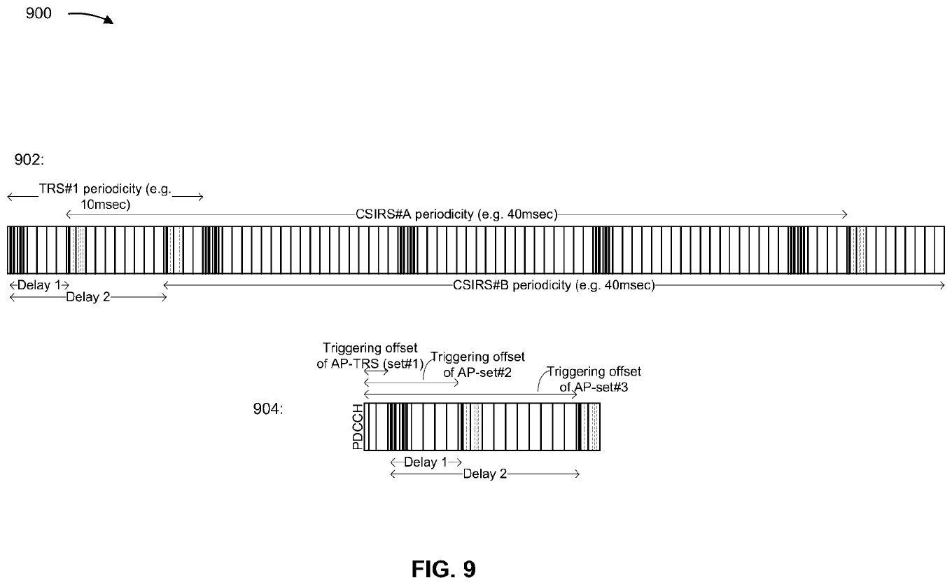

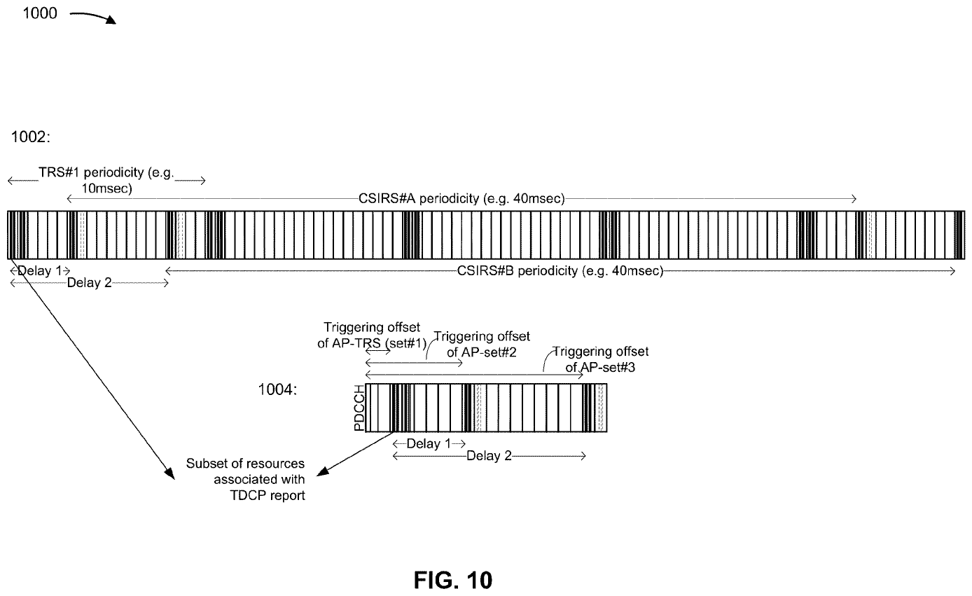

For the first option and the second option, an example of one symbol per delay (lag) is shown in FIG. 6. For the first option and the second option, an example of two symbols per delay (lag) is shown in FIG. 7. For one symbol per delay (lag), examples of the periodic TRS and CSI-RS case and the aperiodic TRS and CSI-RS case are shown in FIG. 9. For two symbols per delay (lag), examples of the periodic TRS and CSI-RS case and the aperiodic TRS and CSI-RS case are shown in FIG. 10.

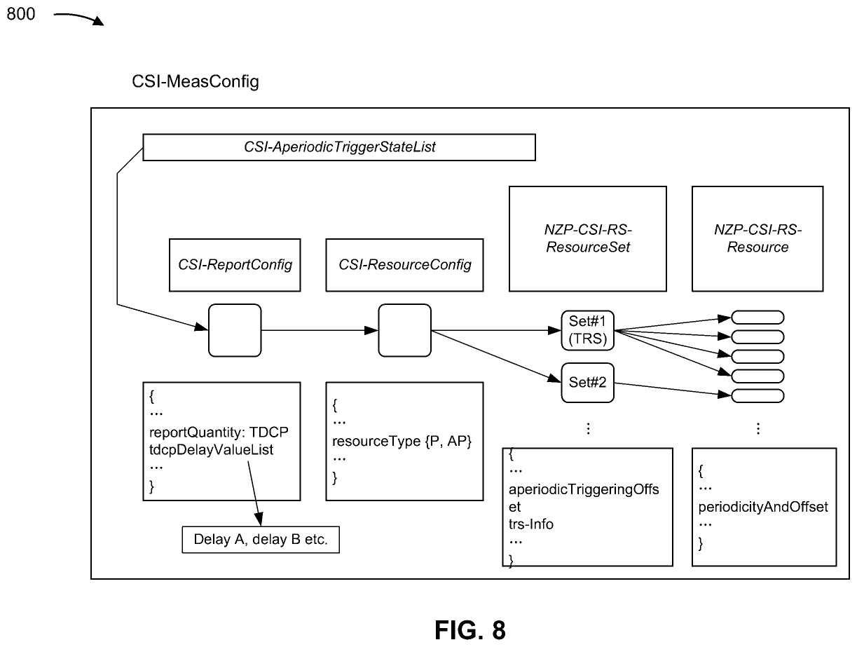

In some aspects, the UE may receive, from the network node, a channel state information (CSI) report configuration, as part of a CSI measurement configuration, that indicates a delay value. In some aspects, the delay (lag) value may be explicitly configured with the CSI report configuration (CSI-reportConfig) parameter. For example, the delay (lag) value may be 5 or 10 slots, or 5 or 10 ms. The delay (lag) value may be explicitly configured because the delay (lag) value may be straightforwardly derived from the periodicity and offset (periodicityAndOffset), due to ambiguity between a value that is equal to a first offset minus a second offset (e.g., (offset1-offset2), or a value that is equal to a periodicity minus a difference between the first offset and the second offset (e.g., periodicity-(offset1-offset2)). For sets of CSI-RS resources other than the first set, a TRS information (trs-info) parameter may not be configured. An example of the CSI report configuration is shown in FIG. 8.

In some aspects, the delay (lag) may be associated with a CSI-RS resource pair, rather than a resource set pair. A subset of one or two resources (e.g., only one or two resources) in the first set (TRS) may be associated with the TDCP report. Resources in the first set associated with the TDCP report may be implicitly determined by the configured delay (lag). When Y>1 delays (lags) are configured for the TDCP report, a plurality of delays (lags) (e.g., all delays or lags) may be associated with the same one or two resources in the first set. As a result, the UE may only need to buffer a demodulation of one or two TRS symbols (e.g., one or two CSI-RS resources within a first resource set, and not all four CSI-RS resources within the first resource set), to calculate a time correlation (e.g., TDCP) with upcoming CSI-RS resource(s) (e.g., a second resource set).

As shown in FIG. 5 by reference number 506, the UE may transmit, to the network node, the TDCP report indicating a time correlation calculation based at least in part on the delay between the first set of CSI-RS resources for the TRS and the second set of CSI-RS resources. The UE may perform measurements associated with the first set of CSI-RS resources and the second set of CSI-RS resources, and based at least in part on the measurements, the UE may perform the time correlation calculation. The UE may indicate the time correlation calculation in the TDCP report transmitted to the network node.

In some aspects, after a CSI report configuration or reconfiguration, a serving cell activation, a bandwidth part (BWP) change, or an activation of a semi-persistent CSI (SP-CSI), the UE may report a CSI report only after receiving at least one CSI-RS transmission occasion for channel measurement and CSI-RS and/or a CSI interference management (CSI-IM) occasion for interference measurement, no later than a CSI reference resource, and the UE may otherwise drop the CSI report. When a discontinuous reception (DRX) is configured, the UE may report the CSI report only when receiving at least one CSI-RS transmission occasion for channel measurement and CSI-RS and/or a CSI-IM occasion for interference measurement in a DRX active time, and no later than the CSI reference resource, and the UE may otherwise drop the CSI report.

In some aspects, the CSI reference resource may be defined for validation testing (e.g., a target block error rate (BLER) of 10%) with a reported channel quality indicator (CQI) (and a precoding matrix indicator (PMI), if also reported). The CSI reference resource may be associated with a frequency resource. The frequency resource may be the same as a measured CSI-RS in a frequency domain. The CSI reference resource may be associated with a time resource. The time resource may be associated with a valid downlink slot n-n_{CSI_ref} (prior to an uplink slot n in which a CSI is reported). For a periodic or semi-persistent report, n_{CSI_ref} may be a smallest value that is ≥4·2^{μ}^{_{DL}} (single CSI-RS) or is ≥5·2^{μ}^{_{DL}} (multiple CSI-RSs), such that slot n-n_{CSI_ref} corresponds to a valid downlink slot. For an aperiodic report, n_{CSI_ref} may be the smallest value that is ≥[Z′/14], such that slot n-n_{CSI_ref} corresponds to a valid downlink slot (where Z′ (in symbols) is a required processing timeline for a CSI-RS to a physical uplink shared channel (PUSCH) for reporting). In other words, for a CSI reference resource slot n_{ref} and a report slot n, n_{ref} is ≥4 or 5 slots for the periodic or semi-persistent report, or is ≥[Z′/14] slots for the aperiodic report. An assumed physical downlink shared channel (PDSCH) pattern may include used symbols within a slot, a DMRS pattern, a subcarrier spacing (SCS), and/or a layer mapping pattern associated with a reported PMI.

In some aspects, the UE may transmit the TDCP report associated with the delay based at least in part on a receipt of at least one pair of CSI-RS resources associated with the delay no later than a quantity of symbols prior to a PUSCH used for transmitting the TDCP report (regardless of whether a CSI reference resource (slot) is defined for the TDCP report or not). In some aspects, when the DRX is configured, the UE may transmit the TDCP report associated with the delay based at least in part on a receipt of at least one pair of CSI-RS resources associated with the delay in the DRX active time no later than a quantity of symbols prior to a PUSCH used for transmitting the TDCP report.

In some aspects, after a TDCP report configuration or reconfiguration, the serving cell activation, the BWP change, or the activation of SP-CSI (TDCP), the UE may transmit the TDCP report associated with a delay (lag), only after receiving at least one pair of (single-port) CSI-RS resources associated with the delay (lag), no later than Z′ symbols prior to the PUSCH. Otherwise, the UE may drop the TDCP report (no update), or the UE may report an invalid TDCP value (e.g., a zero time correlation). The Z′ symbols may be associated with a TDCP timeline, which may reuse existing Z₁′, Z₂′, or Z₃′ symbols, or which may be associated with a new timeline. The delay (lag) may be associated with resource pairs from the first set (TRS) and the second set (e.g., set #>1).

In some aspects, when the DRX is configured, the UE may transmit the TDCP report associated with the delay (lag), only after receiving at least one pair of (single-port) CSI-RS resources associated with the delay (lag) in the DRX active time, no later than the Z′ symbols prior to the PUSCH. Otherwise, the UE may drop the TDCP report (no update), or the UE may report the invalid TDCP value (e.g., the zero time correlation). The Z′ symbols may be associated with the TDCP timeline, which may reuse the existing Z₁′, Z₂′, or Z₃′ symbols, or which may be associated with the new timeline. The delay (lag) may be associated with resource pairs from the first set (TRS) and the second set (e.g., set #>1).

In some aspects, when the TDCP report is based at least in part on an aperiodic reference signal (e.g., TRS and CSI-RS), measured CSI-RS resources (e.g., all measured CSI-RS resources) may be between a physical downlink control channel (PDCCH) and the PUSCH for the reporting. The delay (lag) between two (single-port) CSI-RS resources may be relatively large (e.g., ten slots), plus a timeline (e.g., Z′ symbols). Thus, a PDCCH-to-PUSCH slot offset (K2) may also need to be relatively large.

In some aspects, the UE may receive, from the network node, a first stage PDCCH that triggers the TRS, the second set of CSI-RS resources, and a TDCP related measurement. The UE may receive, from the network node, a second stage PDCCH that triggers the TDCP report via a PUSCH. A same triggering state may be associated with the first PDCCH and the second stage PDCCH, and the second PDCCH or the PUSCH may be within a timer after a last CSI-RS resource associated with the TDCP report.

In some aspects, for a PUSCH scheduling associated with the PDCCH-to-PUSCH slot offset (K2) and the aperiodic reference signal (e.g., TRS and CSI-RS), a two stage PDCCH may be used to trigger an aperiodic report based at least in part on the aperiodic reference signal. The first stage PDCCH (PDCCH1) may trigger the aperiodic reference signal and a TDCP related measurement. The second stage PDCCH (PDCCH2) may trigger the aperiodic report via a scheduled PUSCH. A linkage between the first stage PDCCH and the second stage PDCCH may be the same triggering state in downlink control information (DCI) of both PDCCHs. Further, for the linkage, the second stage PDCCH or the scheduled PUSCH (for the aperiodic report) may be within a timer after the last CSI-RS resource (or CSI reference resource) associated with the TDCP report.

As indicated above, FIG. 5 is provided as an example. Other examples may differ from what is described with regard to FIG. 5.

FIG. 6 is a diagram illustrating an example 600 associated with a TDCP reporting, in accordance with the present disclosure.

As shown by reference number 602, in a first option, with a one symbol per delay (lag), a first set (Set #1) (TRS) may be associated with four non-zero-power (NZP) CSI-RS resources. A second set (Set #2) may have fewer NZP CSI-RS resources (e.g., one NZP CSI-RS resource), as compared to the first set. The second set may be associated with a first delay (e.g., delay A). A third set (Set #3) may have fewer NZP CSI-RS resources (e.g., one NZP CSI-RS resource), as compared to the first set. The third set may be associated with a second delay (e.g., delay B). In other words, other sets of CSI-RS resources may each be associated with one delay (lag).

As shown by reference number 604, in a second option, with the one symbol per delay (lag), the first set (Set #1) (TRS) may be associated with four NZP CSI-RS resources. The second set (Set #2) may have fewer NZP CSI-RS resources (e.g., two NZP CSI-RS resources), as compared to the first set. The second set may be associated with the first delay (e.g., delay A) and the second delay (e.g., delay B). In other words, CSI-RS resources other than CSI-RS resources in the first set may be configured in the second set, and the CSI-RS resources in the second set may be associated with one or more delays (lags).

As indicated above, FIG. 6 is provided as an example. Other examples may differ from what is described with regard to FIG. 6.

FIG. 7 is a diagram illustrating an example 700 associated with a TDCP reporting, in accordance with the present disclosure.

As shown by reference number 702, in a first option, with two symbols per delay (lag), a first set (Set #1) (TRS) may be associated with four NZP CSI-RS resources. A second set (Set #2) may have fewer NZP CSI-RS resources (e.g., two NZP CSI-RS resources), as compared to the first set. NZP CSI-RS resources of the second set may be associated with a first delay (e.g., delay A). A third set (Set #3) may have fewer NZP CSI-RS resources (e.g., one NZP CSI-RS resource), as compared to the first set. NZP CSI-RS resources of the third set may be associated with a second delay (e.g., delay B). In other words, other sets of CSI-RS resources may each be associated with one delay (lag).

As shown by reference number 704, in a second option, with the two symbols per delay (lag), the first set (Set #1) (TRS) may be associated with four NZP CSI-RS resources. The second set may include a first group of NZP CSI-RS resources, which may be associated with the first delay (e.g., delay A). The second set may include a second group of NZP CSI-RS resources, which may be associated with the second delay (e.g., delay B). In other words, CSI-RS resources other than CSI-RS resources in the first set may be configured in the second set, and the CSI-RS resources in the second set may be associated with one or more delays (lags).

As indicated above, FIG. 7 is provided as an example. Other examples may differ from what is described with regard to FIG. 7.

FIG. 8 is a diagram illustrating an example 800 associated with a TDCP reporting, in accordance with the present disclosure.

As shown in FIG. 8, a CSI measurement configuration (CSI-MeasConfig) may indicate a CSI aperiodic trigger state list (CSI-AperiodicTriggerStateList). The CSI aperiodic trigger state list may indicate a CSI report configuration (CSI-ReportConfig), which may indicate a report quantity. The report quantity may indicate a TDCP delay value list (e.g., delay A, delay B, and so on). The TDCP delay value list may indicate delay (lag) values. The CSI report configuration may indicate a CSI resource configuration (ResourceConfig), which may indicate a resource type (e.g., periodic or aperiodic). The CSI resource configuration may indicate an NZP CSI-RS resource set (NZP-CSI-RS-ResourceSet) (e.g., a first set (TRS) and a second set). The NZP CSI-RS resource set may indicate an aperiodic triggering offset and/or TRS information. The NZP CSI-RS resource set may indicate an NZP CSI-RS resource (NZP-CSI-RS-Resource), which may indicate a periodicity and offset (periodicityAndOffset).

As indicated above, FIG. 8 is provided as an example. Other examples may differ from what is described with regard to FIG. 8.

FIG. 9 is a diagram illustrating an example 900 associated with a TDCP reporting, in accordance with the present disclosure.

As shown by reference number 902, in a periodic TRS and CSI-RS case, with one symbol per delay (lag), a TRS (TRS #1) periodicity (e.g., 10 ms), a first CSI-RS (CSI-RS #A) periodicity (e.g., 40 ms), and a second CSI-RS (CSI-RS #B) periodicity (e.g., 40 ms) may be configured. The second CSI-RS periodicity may be the same as the first CSI-RS periodicity. A first delay may be associated with a start of the TRS periodicity and a start of the first CSI-RS periodicity. A second delay may be associated with the start of the TRS periodicity and a start of the second CSI-RS periodicity.

As shown by reference number 904, in an aperiodic TRS and CSI-RS case, with one symbol per delay (lag), and a triggering offset of an aperiodic TRS (set #1), a network node may transmit a PDCCH. A triggering offset of an aperiodic set (set #2), and a triggering offset of an aperiodic set (set #3) may be configured. A first delay may start from a resource in the aperiodic TRS (set #1) associated with a TDCP report, and the first delay may end at an end of the triggering offset of the aperiodic set (set #2). A second delay may start from the resource in the aperiodic TRS (set #1) associated with the TDCP report, and the second delay may end at an end of the triggering offset of the aperiodic set (set #2). The triggering offset of an aperiodic TRS (set #1) may be associated with the PDCCH and the resource in the aperiodic TRS (set #1) associated with a TDCP report.

As indicated above, FIG. 9 is provided as an example. Other examples may differ from what is described with regard to FIG. 9.

FIG. 10 is a diagram illustrating an example 1000 associated with a TDCP reporting, in accordance with the present disclosure.

As shown by reference number 1002, in a periodic TRS and CSI-RS case, with two symbols per delay (lag), a TRS (TRS #1) periodicity (e.g., 10 ms), a first CSI-RS (CSI-RS #A) periodicity (e.g., 40 ms), and a second CSI-RS (CSI-RS #B) periodicity (e.g., 40 ms) may be configured. The second CSI-RS periodicity may be the same as the first CSI-RS periodicity. A first delay may be associated with a start of the TRS periodicity and a start of the first CSI-RS periodicity. A second delay may be associated with the start of the TRS periodicity and a start of the second CSI-RS periodicity.

As shown by reference number 1004, in an aperiodic TRS and CSI-RS case, with two symbols per delay (lag), a network node may transmit a PDCCH. A triggering offset of an aperiodic TRS (set #1), a triggering offset of an aperiodic set (set #2), and a triggering offset of an aperiodic set (set #3) may be configured. A first delay may start from a resource in the aperiodic TRS (set #1) associated with a TDCP report, and the first delay may end at an end of the triggering offset of the aperiodic set (set #2). A second delay may start from the resource in the aperiodic TRS (set #1) associated with the TDCP report, and the second delay may end at an end of the triggering offset of the aperiodic set (set #2). The triggering offset of an aperiodic TRS (set #1) may be associated with the PDCCH and the resource in the aperiodic TRS (set #1) associated with a TDCP report.

As indicated above, FIG. 10 is provided as an example. Other examples may differ from what is described with regard to FIG. 10.

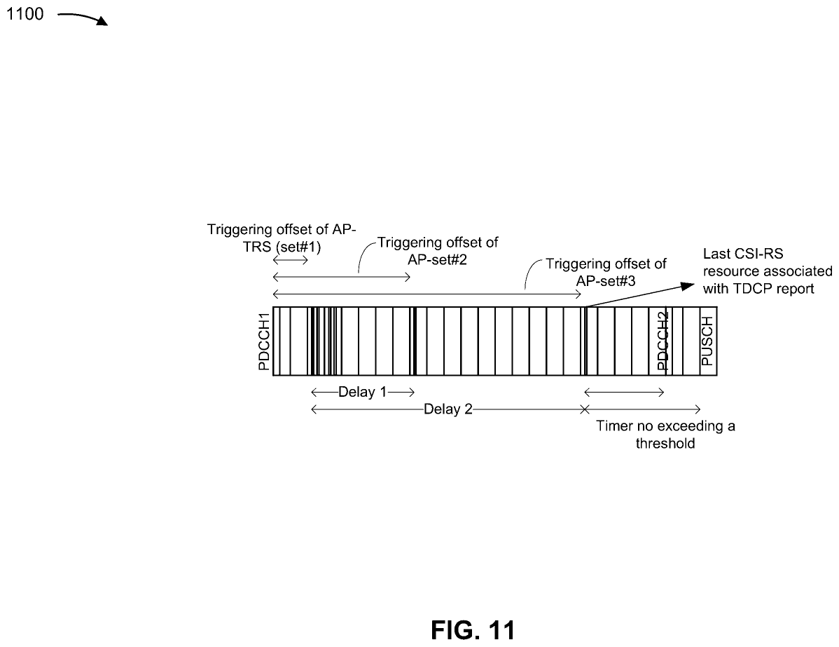

FIG. 11 is a diagram illustrating an example 1100 associated with a TDCP reporting, in accordance with the present disclosure.

As shown in FIG. 11, a network node may transmit a first PDCCH, which may trigger an aperiodic reference signal and a TDCP related measurement. A triggering offset of an aperiodic TRS (set #1), a triggering offset of an aperiodic set (set #2), and a triggering offset of an aperiodic set (set #3) may be configured. A first delay may start from a resource in the aperiodic TRS (set #1) associated with a TDCP report, and the first delay may end at an end of the triggering offset of the aperiodic set (set #2). A second delay may start from the resource in the aperiodic TRS (set #1) associated with the TDCP report, and the second delay may end at an end of the triggering offset of the aperiodic set (set #2). A network node may transmit a second PDCCH, which may trigger an aperiodic report via a PUSCH. The first PDCCH and the second PDCCH may be associated with a same triggering state (or same DCI). The second PDCCH or the PUSCH may be within a threshold timer after a last CSI-RS resource associated with the TDCP report.

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., UE 120) performs operations associated with TDCP reporting.

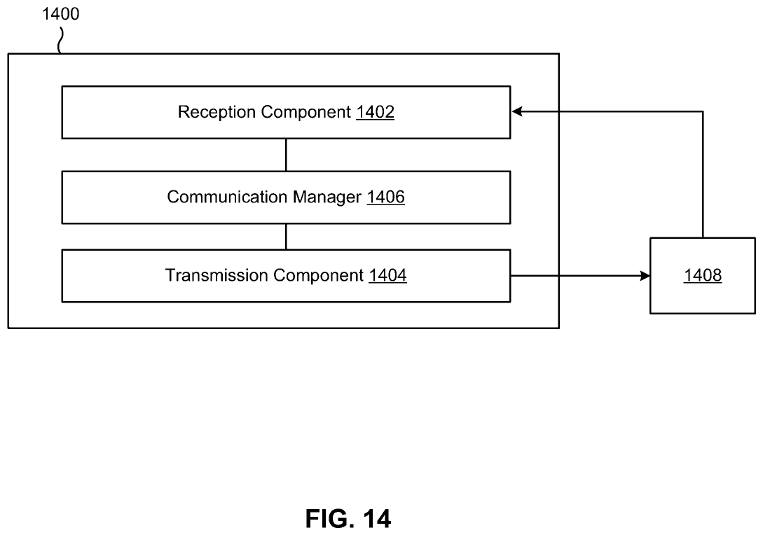

As shown in FIG. 12, in some aspects, process 1200 may include receiving a TRS via a first set of CSI-RS resources (block 1210). For example, the UE (e.g., using reception component 1402 and/or communication manager 1406, depicted in FIG. 14) may receive a TRS via a first set of CSI-RS resources, as described above.

As further shown in FIG. 12, in some aspects, process 1200 may include receiving a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources (block 1220). For example, the UE (e.g., using reception component 1402 and/or communication manager 1406, depicted in FIG. 14) may receive a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources, as described above.

As further shown in FIG. 12, in some aspects, process 1200 may include transmitting a TDCP report indicating a time correlation calculation based at least in part on the delay between the first set of CSI-RS resources for the TRS and the second set of CSI-RS resources (block 1230). For example, the UE (e.g., using transmission component 1404 and/or communication manager 1406, depicted in FIG. 14) may transmit a TDCP report indicating a time correlation calculation based at least in part on the delay between the first set of CSI-RS resources for the TRS and the second set of CSI-RS resources, as described above.

Process 1200 may include additional aspects, such as any single aspect or any combination of aspects described below and/or in connection with one or more other processes described elsewhere herein.

In a first aspect, the second set of CSI-RS resources is associated with one delay.

In a second aspect, alone or in combination with the first aspect, the TRS is a periodic TRS and the CSI-RS is a periodic CSI-RS.

In a third aspect, alone or in combination with one or more of the first and second aspects, the TRS is an aperiodic TRS and the CSI-RS is an aperiodic CSI-RS.

In a fourth aspect, alone or in combination with one or more of the first through third aspects, the second set of CSI-RS resources is associated with more than one delay.

In a fifth aspect, alone or in combination with one or more of the first through fourth aspects, each delay is associated with a group of CSI-RS resources within the second set of CSI-RS resources, and the group of CSI-RS resources having one or two CSI-RS resources.

In a sixth aspect, alone or in combination with one or more of the first through fifth aspects, process 1200 includes receiving a CSI report configuration, as part of a CSI measurement configuration, that indicates a delay value.

In a seventh aspect, alone or in combination with one or more of the first through sixth aspects, a subset of resources in the first set of CSI-RS resources for the TRS are associated with the TDCP report, and the subset of resources in the first set of CSI-RS resources for the TRS being based at least in part on the delay.

In an eighth aspect, alone or in combination with one or more of the first through seventh aspects, multiple delays are configured for the TDCP report, and each delay of the multiple delays is associated with a same subset of resources in the first set of CSI-RS resources for the TRS.

In a ninth aspect, alone or in combination with one or more of the first through eighth aspects, process 1200 includes transmitting the TDCP report associated with the delay based at least in part on a receipt of at least one pair of CSI-RS resources associated with the delay no later than a quantity of symbols prior to a PUSCH used for transmitting the TDCP report.

In a tenth aspect, alone or in combination with one or more of the first through ninth aspects, a DRX is configured, and process 1200 includes transmitting the TDCP report associated with the delay based at least in part on a receipt of at least one pair of CSI-RS resources associated with the delay in a DRX active time no later than a quantity of symbols prior to a PUSCH used for transmitting the TDCP report.

In an eleventh aspect, alone or in combination with one or more of the first through tenth aspects, process 1200 includes receiving a first stage PDCCH that triggers the TRS, the second set of CSI-RS resources, and a TDCP related measurement, and receiving a second stage PDCCH that triggers the TDCP report via a PUSCH.

In a twelfth aspect, alone or in combination with one or more of the first through eleventh aspects, a same triggering state being associated with the first PDCCH and the second stage PDCCH, and the second PDCCH or the PUSCH being within a timer after a last CSI-RS resource associated with the TDCP report.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with TDCP reporting.

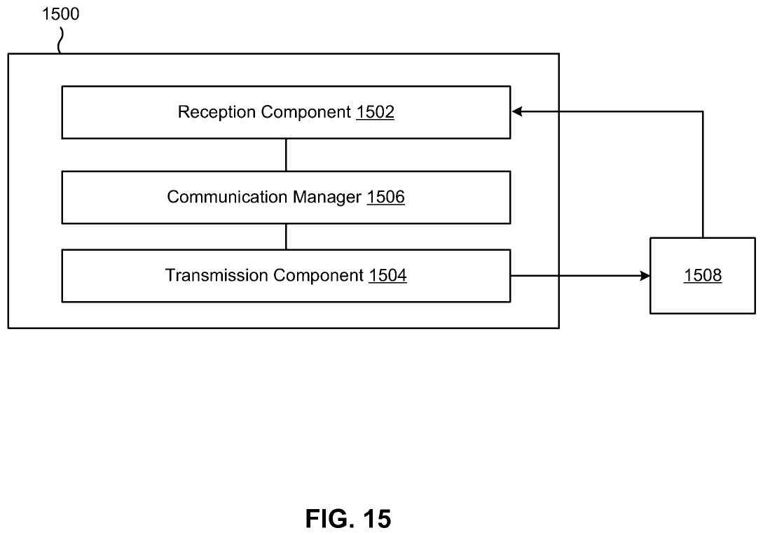

As shown in FIG. 13, in some aspects, process 1300 may include transmitting a TRS via a first set of CSI-RS resources (block 1310). For example, the network node (e.g., using transmission component 1504 and/or communication manager 1506, depicted in FIG. 15) may transmit a TRS via a first set of CSI-RS resources, as described above.

As further shown in FIG. 13, in some aspects, process 1300 may include transmitting a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources (block 1320). For example, the network node (e.g., using transmission component 1504 and/or communication manager 1506, depicted in FIG. 15) may transmit a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources, as described above.

As further shown in FIG. 13, in some aspects, process 1300 may include receiving a TDCP report indicating a time correlation calculation based at least in part on the delay between the first set of CSI-RS resources for the TRS and the second set of CSI-RS resources (block 1330). For example, the network node (e.g., using reception component 1502 and/or communication manager 1506, depicted in FIG. 15) may receive a TDCP report indicating a time correlation calculation based at least in part on the delay between the first set of CSI-RS resources for the TRS and the second set of CSI-RS resources, as described above.

Process 1300 may include additional aspects, such as any single aspect or any combination of aspects described below and/or in connection with one or more other processes described elsewhere herein.

In a first aspect, the second set of CSI-RS resources is associated with one delay.

In a second aspect, alone or in combination with the first aspect, the TRS is a periodic TRS and the CSI-RS is a periodic CSI-RS.

In a third aspect, alone or in combination with one or more of the first and second aspects, the TRS is an aperiodic TRS and the CSI-RS is an aperiodic CSI-RS.

In a fourth aspect, alone or in combination with one or more of the first through third aspects, the second set of CSI-RS resources is associated with more than one delay.

In a fifth aspect, alone or in combination with one or more of the first through fourth aspects, each delay is associated with a group of CSI-RS resources within the second set of CSI-RS resources, and the group of CSI-RS resources having one or two CSI-RS resources.

In a sixth aspect, alone or in combination with one or more of the first through fifth aspects, process 1300 includes transmitting a CSI report configuration, as part of a CSI measurement configuration, that indicates a delay value.

In a seventh aspect, alone or in combination with one or more of the first through sixth aspects, a subset of resources in the first set of CSI-RS resources for the TRS are associated with the TDCP report, and the subset of resources in the first set of CSI-RS resources for the TRS are based at least in part on the delay.

In an eighth aspect, alone or in combination with one or more of the first through seventh aspects, multiple delays are configured for the TDCP report, and each delay of the multiple delays is associated with a same subset of resources in the first set of CSI-RS resources for the TRS.

In a ninth aspect, alone or in combination with one or more of the first through eighth aspects, process 1300 includes receiving the TDCP report associated with the delay based at least in part on a transmission of at least one pair of CSI-RS resources associated with the delay no later than a quantity of symbols prior to a PUSCH used for receiving the TDCP report.

In a tenth aspect, alone or in combination with one or more of the first through ninth aspects, a DRX is configured, and process 1300 includes receiving the TDCP report associated with the delay based at least in part on a transmission of at least one pair of CSI-RS resources associated with the delay in a DRX active time no later than a quantity of symbols prior to a PUSCH used for receiving the TDCP report.

In an eleventh aspect, alone or in combination with one or more of the first through tenth aspects, process 1300 includes transmitting a first stage PDCCH that triggers the TRS, the second set of CSI-RS resources, and a TDCP related measurement, and transmitting a second stage PDCCH that triggers the TDCP report via a PUSCH.

In a twelfth aspect, alone or in combination with one or more of the first through eleventh aspects, a same triggering state is associated with the first PDCCH and the second stage PDCCH, and the second PDCCH or the PUSCH is within a timer after a last CSI-RS resource associated with the TDCP report.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 5-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive a TRS via a first set of CSI-RS resources. The reception component 1402 may receive a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources. The transmission component 1404 may transmit a TDCP report indicating a time correlation calculation based at least in part on the delay between the first set of CSI-RS resources for the TRS and the second set of CSI-RS resources.

The reception component 1402 may receive a CSI report configuration, as part of a CSI measurement configuration, that indicates a delay value. The reception component 1402 may receive a first stage PDCCH that triggers the TRS, the second set of CSI-RS resources, and a TDCP related measurement. The reception component 1402 may receive a second stage PDCCH that triggers the TDCP report via a PUSCH.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 5-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a TRS via a first set of CSI-RS resources. The transmission component 1504 may transmit a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources. The reception component 1502 may receive a TDCP report indicating a time correlation calculation based at least in part on the delay between the first set of CSI-RS resources for the TRS and the second set of CSI-RS resources.

The transmission component 1504 may transmit a CSI report configuration, as part of a CSI measurement configuration, that indicates a delay value. The transmission component 1504 may transmit a first stage PDCCH that triggers the TRS, the second set of CSI-RS resources, and a TDCP related measurement. The transmission component 1504 may transmit a second stage PDCCH that triggers the TDCP report via a PUSCH.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving a tracking reference signal (TRS) via a first set of channel state information reference signal (CSI-RS) resources; receiving a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and transmitting a time domain channel properties (TDCP) report indicating a time correlation calculation based at least in part on the delay between the first set of CSI-RS resources for the TRS and the second set of CSI-RS resources.

Aspect 2: The method of Aspect 1, wherein the second set of CSI-RS resources is associated with one delay.

Aspect 3: The method of any of Aspects 1-2, wherein the TRS is a periodic TRS and the CSI-RS is a periodic CSI-RS.

Aspect 4: The method of any of Aspects 1-3, wherein the TRS is an aperiodic TRS and the CSI-RS is an aperiodic CSI-RS.

Aspect 5: The method of any of Aspects 1-4, wherein the second set of CSI-RS resources is associated with more than one delay.

Aspect 6: The method of any of Aspects 1-5, wherein each delay is associated with a group of CSI-RS resources within the second set of CSI-RS resources, and the group of CSI-RS resources having one or two CSI-RS resources.

Aspect 7: The method of any of Aspects 1-6, further comprising: receiving a channel state information (CSI) report configuration, as part of a CSI measurement configuration, that indicates a delay value.

Aspect 8: The method of any of Aspects 1-7, wherein a subset of resources in the first set of CSI-RS resources for the TRS are associated with the TDCP report, and the subset of resources in the first set of CSI-RS resources for the TRS being based at least in part on the delay.

Aspect 9: The method of any of Aspects 1-8, wherein multiple delays are configured for the TDCP report, and each delay of the multiple delays is associated with a same subset of resources in the first set of CSI-RS resources for the TRS.

Aspect 10: The method of any of Aspects 1-9, wherein transmitting the TDCP report associated with the delay is based at least in part on a receipt of at least one pair of CSI-RS resources associated with the delay no later than a quantity of symbols prior to a physical uplink shared channel (PUSCH) used for transmitting the TDCP report.

Aspect 11: The method of any of Aspects 1-10, wherein a discontinuous reception (DRX) is configured, and transmitting the TDCP report associated with the delay is based at least in part on a receipt of at least one pair of CSI-RS resources associated with the delay in a DRX active time no later than a quantity of symbols prior to a physical uplink shared channel (PUSCH) used for transmitting the TDCP report.

Aspect 12: The method of any of Aspects 1-11, further comprising: receiving a first stage physical downlink control channel (PDCCH) that triggers the TRS, the second set of CSI-RS resources, and a TDCP related measurement; and receiving a second stage PDCCH that triggers the TDCP report via a physical uplink shared channel (PUSCH).

Aspect 13: The method of Aspect 12, wherein a same triggering state being associated with the first PDCCH and the second stage PDCCH, and the second PDCCH or the PUSCH being within a timer after a last CSI-RS resource associated with the TDCP report.

Aspect 14: A method of wireless communication performed by a network node, comprising: transmitting a tracking reference signal (TRS) via a first set of channel state information reference signal (CSI-RS) resources; transmitting a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and receiving a time domain channel properties (TDCP) report indicating a time correlation calculation based at least in part on the delay between the first set of CSI-RS resources for the TRS and the second set of CSI-RS resources.

Aspect 15: The method of Aspect 14, wherein the second set of CSI-RS resources is associated with one delay.

Aspect 16: The method of any of Aspects 14-15, wherein the TRS is a periodic TRS and the CSI-RS is a periodic CSI-RS.

Aspect 17: The method of any of Aspects 14-16, wherein the TRS is an aperiodic TRS and the CSI-RS is an aperiodic CSI-RS.

Aspect 18: The method of any of Aspects 14-17, wherein the second set of CSI-RS resources is associated with more than one delay.

Aspect 19: The method of any of Aspects 14-18, wherein each delay is associated with a group of CSI-RS resources within the second set of CSI-RS resources, and the group of CSI-RS resources having one or two CSI-RS resources.

Aspect 20: The method of any of Aspects 14-19, further comprising: transmitting a channel state information (CSI) report configuration, as part of a CSI measurement configuration, that indicates a delay value.

Aspect 21: The method of any of Aspects 14-20, wherein a subset of resources in the first set of CSI-RS resources for the TRS are associated with the TDCP report, and the subset of resources in the first set of CSI-RS resources for the TRS being based at least in part on the delay.

Aspect 22: The method of any of Aspects 14-21, wherein multiple delays are configured for the TDCP report, and each delay of the multiple delays is associated with a same subset of resources in the first set of CSI-RS resources for the TRS.

Aspect 23: The method of any of Aspects 14-22, wherein receiving the TDCP report associated with the delay is based at least in part on a transmission of at least one pair of CSI-RS resources associated with the delay no later than a quantity of symbols prior to a physical uplink shared channel (PUSCH) used for receiving the TDCP report.

Aspect 24: The method of any of Aspects 14-23, wherein a discontinuous reception (DRX) is configured, and receiving the TDCP report associated with the delay is based at least in part on a transmission of at least one pair of CSI-RS resources associated with the delay in a DRX active time no later than a quantity of symbols prior to a physical uplink shared channel (PUSCH) used for receiving the TDCP report.

Aspect 25: The method of any of Aspects 14-24, further comprising: transmitting a first stage physical downlink control channel (PDCCH) that triggers the TRS, the second set of CSI-RS resources, and a TDCP related measurement; and transmitting a second stage PDCCH that triggers the TDCP report via a physical uplink shared channel (PUSCH).

Aspect 26: The method of Aspect 25, wherein a same triggering state being associated with the first PDCCH and the second stage PDCCH, and the second PDCCH or the PUSCH being within a timer after a last CSI-RS resource associated with the TDCP report.

Aspect 27: An apparatus for wireless communication at a device, comprising a processor; memory coupled with the processor; and instructions stored in the memory and executable by the processor to cause the apparatus to perform the method of one or more of Aspects 1-13.

Aspect 28: A device for wireless communication, comprising a memory and one or more processors coupled to the memory, the one or more processors configured to perform the method of one or more of Aspects 1-13.

Aspect 29: An apparatus for wireless communication, comprising at least one means for performing the method of one or more of Aspects 1-13.

Aspect 30: A non-transitory computer-readable medium storing code for wireless communication, the code comprising instructions executable by a processor to perform the method of one or more of Aspects 1-13.

Aspect 31: A non-transitory computer-readable medium storing a set of instructions for wireless communication, the set of instructions comprising one or more instructions that, when executed by one or more processors of a device, cause the device to perform the method of one or more of Aspects 1-13.

Aspect 32: An apparatus for wireless communication at a device, comprising a processor; memory coupled with the processor; and instructions stored in the memory and executable by the processor to cause the apparatus to perform the method of one or more of Aspects 14-26.

Aspect 33: A device for wireless communication, comprising a memory and one or more processors coupled to the memory, the one or more processors configured to perform the method of one or more of Aspects 14-26.

Aspect 34: An apparatus for wireless communication, comprising at least one means for performing the method of one or more of Aspects 14-26.

Aspect 35: A non-transitory computer-readable medium storing code for wireless communication, the code comprising instructions executable by a processor to perform the method of one or more of Aspects 14-26.

Aspect 36: A non-transitory computer-readable medium storing a set of instructions for wireless communication, the set of instructions comprising one or more instructions that, when executed by one or more processors of a device, cause the device to perform the method of one or more of Aspects 14-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive a tracking reference signal (TRS) via a first set of channel state information reference signal (CSI-RS) resources;
receive a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and
transmit a time domain channel properties (TDCP) report indicating a time correlation calculation based at least in part on the delay between the first set of CSI-RS resources for the TRS and the second set of CSI-RS resources.

2. The apparatus of claim 1, wherein the second set of CSI-RS resources is associated with one delay.

3. The apparatus of claim 1, wherein the TRS is a periodic TRS and the CSI-RS is a periodic CSI-RS.

4. The apparatus of claim 1, wherein the TRS is an aperiodic TRS and the CSI-RS is an aperiodic CSI-RS.

5. The apparatus of claim 1, wherein the second set of CSI-RS resources is associated with more than one delay.

6. The apparatus of claim 1, wherein each delay is associated with a group of CSI-RS resources within the second set of CSI-RS resources, and the group of CSI-RS resources having one or two CSI-RS resources.

7. The apparatus of claim 1, wherein the one or more processors are further configured to:
receive a channel state information (CSI) report configuration, as part of a CSI measurement configuration, that indicates a delay value.

8. The apparatus of claim 1, wherein a subset of resources in the first set of CSI-RS resources for the TRS are associated with the TDCP report, and the subset of resources in the first set of CSI-RS resources for the TRS being based at least in part on the delay.

9. The apparatus of claim 1, wherein multiple delays are configured for the TDCP report, and each delay of the multiple delays is associated with a same subset of resources in the first set of CSI-RS resources for the TRS.

10. The apparatus of claim 1, wherein the one or more processors are configured to transmit the TDCP report associated with the delay based at least in part on a receipt of at least one pair of CSI-RS resources associated with the delay no later than a quantity of symbols prior to a physical uplink shared channel (PUSCH) used for transmitting the TDCP report.

11. The apparatus of claim 1, wherein a discontinuous reception (DRX) is configured, and the one or more processors are configured to transmit the TDCP report associated with the delay based at least in part on a receipt of at least one pair of CSI-RS resources associated with the delay in a DRX active time no later than a quantity of symbols prior to a physical uplink shared channel (PUSCH) used for transmitting the TDCP report.

12. The apparatus of claim 1, wherein the one or more processors are further configured to:
receive a first stage physical downlink control channel (PDCCH) that triggers the TRS, the second set of CSI-RS resources, and a TDCP related measurement; and
receive a second stage PDCCH that triggers the TDCP report via a physical uplink shared channel (PUSCH).

13. The apparatus of claim 12, wherein a same triggering state being associated with the first PDCCH and the second stage PDCCH, and the second PDCCH or the PUSCH being within a timer after a last CSI-RS resource associated with the TDCP report.

14. An apparatus for wireless communication at a network node, comprising:
a memory; and
one or more processors, coupled to the memory, configured to:
transmit a tracking reference signal (TRS) via a first set of channel state information reference signal (CSI-RS) resources;
transmit a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and
receive a time domain channel properties (TDCP) report indicating a time correlation calculation based at least in part on the delay between the first set of CSI-RS resources for the TRS and the second set of CSI-RS resources.

15-19. (canceled)

20. The apparatus of claim 14, wherein the one or more processors are further configured to:
transmit a channel state information (CSI) report configuration, as part of a CSI measurement configuration, that indicates a delay value.

21-22. (canceled)

23. The apparatus of claim 14, wherein the one or more processors are configured to receive the TDCP report associated with the delay is based at least in part on a transmission of at least one pair of CSI-RS resources associated with the delay no later than a quantity of symbols prior to a physical uplink shared channel (PUSCH) used for receiving the TDCP report.

24. The apparatus of claim 14, wherein a discontinuous reception (DRX) is configured, and the one or more processors are configured to receive the TDCP report associated with the delay based at least in part on a transmission of at least one pair of CSI-RS resources associated with the delay in a DRX active time no later than a quantity of symbols prior to a physical uplink shared channel (PUSCH) used for receiving the TDCP report.

25. The apparatus of claim 14, wherein the one or more processors are further configured to:
transmit a first stage physical downlink control channel (PDCCH) that triggers the TRS, the second set of CSI-RS resources, and a TDCP related measurement; and
transmit a second stage PDCCH that triggers the TDCP report via a physical uplink shared channel (PUSCH).

26. The apparatus of claim 25, wherein a same triggering state being associated with the first PDCCH and the second stage PDCCH, and the second PDCCH or the PUSCH being within a timer after a last CSI-RS resource associated with the TDCP report.

27. A method of wireless communication performed by a user equipment (UE), comprising:
receiving a tracking reference signal (TRS) via a first set of channel state information reference signal (CSI-RS) resources;
receiving a CSI-RS via a second set of CSI-RS resources, the second set of CSI-RS resources having fewer CSI-RS resources than the first set of CSI-RS resources for a delay between the first set of CSI-RS resources for the TRS and the second set of CSI-RS resources; and
transmitting a time domain channel properties (TDCP) report indicating a time correlation calculation based at least in part on the delay between the first set of CSI-RS resources for the TRS and the second set of CSI-RS resources.

28-30. (canceled)
